(19) United States
(12) Patent Application Publication
(10) Pub. No.: US 2026/0028555 A1
(43) Pub. Date: Jan. 29, 2026

(54) DETERGENT AND USES THEREOF

(71) Applicant: Medivators Inc., Minneapolis, MN (US)

(72) Inventors: Huyen Bui, Brooklyn Park, MN (US); Nam Bui, Brooklyn Park, MN (US); Tuan Nguyen, Chaska, MN (US)

(21) Appl. No.: 19/268,440

(22) Filed: Jul. 14, 2025

Related U.S. Application Data
(60) Provisional application No. 63/676,640, filed on Jul. 29, 2024.

(51) Int. Cl. C11D 3/20; C11D 1/72; C11D 1/722; C11D 3/32; C11D 3/33

(52) U.S. Cl. CPC C11D 3/2086; C11D 1/72; C11D 1/722; C11D 3/2093; C11D 3/323; C11D 3/33

(57) ABSTRACT

A detergent may include a citrate buffer. A detergent may include a surfactant component. A detergent may include a chelator component, wherein a pH of the detergent composition is in a range of from about 6.5 to about 9, and at least one of the citrate buffer, surfactant component and the chelator component are biodegradable.

### CROSS-REFERENCE TO RELATED APPLICATION

This application claims the benefit of priority to U.S. Provisional Patent Application Ser. No. 63/676,640 entitled “DETERGENT AND USES THEREOF,” filed Jul. 29, 2024, the disclosure of which is incorporated herein in its entirety by reference.

### BACKGROUND

A detergent is a chemical compound or mixture of compounds used to remove dirt and grime. Unlike soap, which is typically made from fats and lye, detergents are often synthesized from petrochemicals. Detergents work by reducing the surface tension of water, effectively allowing it to more easily penetrate into surfaces and lift away dirt and oils that water alone would not remove.

### SUMMARY OF THE INVENTION

In some aspects, the techniques described herein relate to a detergent composition including: a citrate buffer; a surfactant component; and a chelator component, wherein a pH of the detergent composition is in a range of from about 6.5 to about 9, and at least one of the citrate buffer, a urea component, surfactant component and the chelator component are biodegradable.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

According to various aspects of the present disclosure, a eco-friendly detergent product is presented. The detergent is considered to be eco-friendly in that at least one of the non-aqueous components in the product is biodegradable. In some examples, all of the non-aqueous components int eh product are biodegradable. To establish the biodegradability of the of the individual components, the component's individual material data sheets can be examined. Additionally, the biodegradability of the of the detergent product and/or the individual components can be determined according to the EPA Safer Choice Standard (published February, 2015) and/or the European Union's Ecolabel standard. Biodegradability can also be determined according to OECD Test No. 310 (2014).

More generally, the detergent product, as well as the individual non-aqueous components are biodegradable in that they can be substances that can be broken down naturally by microorganisms such as bacteria, fungi, and algae. Unlike non-biodegradable materials, which persist in the environment for long periods, biodegradable materials decompose into water, carbon dioxide, and biomass within a relatively short time after disposal. This process depends on various factors including the material's chemical structure, environmental conditions such as temperature and moisture, and the presence of microorganisms. Biodegradable materials are often derived from natural sources, such as plants or animals, although synthetic biodegradable materials have also been developed.

The detergent composition generally includes a citrate buffer, surfactant component, a urea component, and a chelator component. Notably, and in contrast to some existing detergent compositions, the instant detergent composition is the composition is free of an enzyme present in the final composition. That is the detergent composition includes less than 1 wt % enzyme. Indeed if any enzyme is present in the detergent composition, it is by unintentional introduction.

The combination of components in the instantly described detergent composition can provide unexpected synergistic effects that result in superior cleaning performance compared to formulations using similar but different component combinations. As demonstrated herein in the comparative examples, the precise combination of the citrate buffer, the specific surfactant mixture comprising 2-ethyl hexanol EoPo copolymer, longer-chain alcohol ethoxylates, and EO/PO block copolymer, together with the glutamic acid N,N-diacetic acid tetrasodium salt chelator, creates a synergistic cleaning system. This synergy is evidenced by Formula #1's effectiveness while comparative formulas using alternative surfactant combinations or lacking the complete component system failed to achieve effective cleaning performance.

The chelator component can be in a range of from about 1 wt % to about 10 wt % of the detergent composition, in a range of from about 2 wt % to about 5 wt % of the detergent composition, less than, equal to, or greater than about 1 wt %, 0.5, 1, 1.5, 2, 2.5, 3, 3.5, 4, 4.5, 5, 5.5, 6, 6.5, 7, 7.5, 8, 8.5, 9, 9.5, or about 10 wt % of the detergent composition. The chelator component can include one chelator or a mixture of different chelators. Examples of biodegradable chelators that can be included in the detergent composition include glutamic acid and N,N-diacetic acid tetrasodium salt. In some examples Ethylenediaminetetraacetic acid can be included in the chelator component, although it is generally considered to not be biodegradable. In general, the chelator is selected from any chelator that can help to control hard water.

The surfactant component can be in a range of from about 3 wt % to about 20 wt % of the detergent composition, about 4 wt % to about 12 wt % of the detergent composition, less than, equal to, or greater than about 3 wt %, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt % of the detergent composition. The surfactant component can include one surfactant, two surfactants, or even three surfactants. Additional plural numbers are also possible.

If the surfactant component includes a plurality of surfactants, each surfactant can independently range from about 0.5 wt % to about 7 wt % of the detergent composition, about 1 wt % to about 6 wt % of the detergent composition, less than, equal to, or greater than about 0.5 wt %, 1, 1.5, 2, 2.5, 3, 3.5, 4, 4.5, 5, 5.5, 6, 6.5, or about 7 wt % of the detergent composition.

Examples of suitable surfactant components ionic or anionic surfactants, which can include 2-ethyl hexanol EoPo copolymer (9 EO), ethyl hexanol ethoxylated propoxylated, ethylene oxide-propylene oxide copolymer mono(2-ethylhexyl) ether, EO/PO block copolymer, longer-chain alcohol ethoxylates, or a mixture thereof.

The citrate buffer can include a mixture of citric acid, sodium citrate, and sodium carbonate. Citrate buffers can be used to control the pH in systems. They are made from citric acid, a tricarboxylic acid, and its conjugate base, sodium citrate or potassium citrate. The buffer works by balancing the concentrations of these two components to resist changes in hydrogen ion concentration, thereby stabilizing the pH of the detergent. Citric acid (H₃Cit) can lose three protons (H⁺), resulting in three forms: citric acid itself, hydrogen citrate ion (H2Cit⁻), and dihydrogen citrate ion (HCit²⁻). The presence of these multiple ionizable groups makes citrate an effective buffer over a range of pH levels, typically between pH 3.0 and 6.2. The effectiveness of the buffer is due to the equilibrium established between these species and their ability to donate or accept protons in response to changes in the pH of the environment.

The citrate buffer not only maintains the optimal pH range but also can enhance the performance of the surfactant component by stabilizing the surfactant molecules and preventing precipitation in hard water conditions. The chelator component works in conjunction with the citrate buffer to sequester metal ions that would otherwise interfere with surfactant activity, while the urea component provides additional solubilization properties that complement the surfactant system's ability to penetrate and remove soils.

The citrate buffer can be present in a range of from about 0.5 wt % to about 20 wt % of the detergent composition, about 2 wt % to about 10 wt % of the detergent composition, less than, equal to, or greater than about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %.

The urea component includes urea which is useful to solubilize and remove microbes. The urea component can range from about 5 wt % to about 20 wt % of the detergent composition, about 10 wt % to about 15 wt %, less than, equal to, or greater than about 5 wt %, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %.

The balance of the detergent composition that is not the chelator component, surfactant component, and citrate buffer is water. A pH of the detergent composition is in a range of from about 6.5 to about 8.5, about 7 to about 8, less than, equal to, or greater than about 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, or 8.5.

In specific examples, the detergent of the present disclosure can be stable over extended periods of time (i.e., has a long-term stability). The term “long-term stability” refers to a substance undergoing little or no physical and/or chemical desolation or degradation, over extended periods of time. In further specific examples, the detergent of the present disclosure can be stable over extended periods of time, such that at about 1 atm and about 19° C., less than about 5 wt. % of each component independently degrades over about one year. In additional specific examples, the detergent of the present disclosure can be stable over extended periods of time, such that at about 1 atm and about 19° C., at least about 95 wt. % of each component is independently present after about one year. Additionally, at temperatures ranging from 5° C. to 35° C. and relative humidity levels from 30% to 80%, the composition maintains its cleaning effectiveness and pH stability. The composition can be particularly stable when stored in containers that minimize exposure to UV light and oxygen, which can contribute to oxidative degradation of some surfactant components.

Having the detergent be relatively stable over extended periods of time will allow the detergent to retain its effectiveness over that time, ensuring that it will remain useful and active for its intended purpose. In contrast, in those detergents that do not retain their effectiveness over that time, product loss can result, which can be financially costly.

The detergent of the present disclosure can be used to effectively reduce the number of microbes located on a substrate. For example the detergent can remove a microorganism (e.g., virus, fungus, mold, slime mold, algae, yeast, and/or bacterium) from a substrate.

Additionally, by virtue of the substantially neutral pH, the detergent has low corrosion characteristics.

In specific examples, the detergent can effectively clean a substrate. In further specific examples, the detergent can effectively clean the surface of a substrate. In additional specific examples, the detergent can effectively clean a substrate. In further specific examples, the detergent can effectively clean the surface of a substrate.

The detergent of the present disclosure can be formulated for application, depending upon the user's preference as well as the ultimate application of the detergent. Such formulations can include at least one of a spray bottle, motorized sprayer, wipe, cloth, sponge, non-woven fabric, and woven fabric.

Such formulations may be particularly suitable for applying the detergent to a surface of a medical device, hospital surface, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and/or disinfect room. Such liquid formulations may be particularly suitable for applying the detergent to metal, plastic, natural rubber, synthetic rubber, glass, stone, grout, fiberglass, wood, concrete, construction products, and/or building products. Examples of medical devices can include a flexible endoscope, a narrowed lumened accessory device, or a balloon catheter. The foregoing lists are not exhaustive.

In specific examples, the detergent or at least one component of the detergent can be non-toxic. The term “non-toxic” refers to a substance that has a relatively low degree to which it can damage a living or non-living organism. Toxicity can refer to the effect on a whole organism, such as an animal, bacterium, or plant, as well as the effect on a substructure of the organism, such as a cell (cytotoxicity) or an organ (organotoxicity), such as the liver (hepatotoxicity). A central concept of toxicology is that effects are dose-dependent; even water can lead to water intoxication when taken in large enough doses, whereas for even a very toxic substance such as snake venom there is a dose below which there is no detectable toxic effect. Having the detergent be relatively non-toxic will allow a wider range of users be able to safely handle the detergent, without serious safety concerns or risks.

The detergent can be manufactured according to many suitable methods. For example, the aforementioned components of the detergent can be mixed in large-scale reactor. The detergent can be in liquid or powder form.

As a non-limiting example, making a liquid detergent can begin with the preparation of the citrate buffer. To prepare the buffer, citric acid is dissolved in water, and the pH is adjusted to the desired level using sodium citrate until the buffer reaches the aforementioned ideal pH range for many cleaning applications. Next, a surfactant mixture is prepared. This can involve a combination of nonionic surfactants (such as alcohol ethoxylates) for their low foaming properties and anionic surfactants (like sodium lauryl sulfate) for effective soil removal. The surfactants are gently heated and mixed until fully dissolved. The chelator component is added not only as part of the buffer but also for its ability to bind with metal ions in hard water, enhancing the detergent's performance. The mixture is then homogenized and packaged.

As a non-limiting example, forming a powdered detergent can start with the dry blending of powdered citric acid and sodium citrate to form the citrate buffer component. To this blend, a powdered surfactant is added for its strong cleaning capabilities and compatibility in powder form The chelator is also added (in its powdered form. These components are thoroughly mixed in a dry mixer to ensure even distribution. Optionally, additional dry ingredients, such as flow agents or anti-caking agents, might be included to improve the physical properties of the powder. Once the mixture is uniform, it is packaged in moisture-resistant containers to maintain efficacy until use.

### EXAMPLES

Various aspect of the present disclosure can be better understood by reference to the following Examples which are offered by way of illustration. The present invention is not limited to the Examples given herein.

A detergent was prepared having the following combination of surfactants, chelator, and citrate buffer. All components were biodegradable and functioned sufficiently as a detergent. A detergent was deemed effective if it was able to remove an undesired soil from a medical device substrate.

TABLE 1
Materials

| Trade name | Scientific name | (CAS#) |
|---|---|---|
| Dissolvine | Glutamic acid, N,N-diacetic | 51981-21-6 |
| GL47-S | acid, tetrasodium salt (GLDA) | |
| Ecosurf EH9 | 2-Ethyl hexanol EoPo copolymer | 64366-70-7 |
| | (9 EO), Ethyl hexanol ethoxylated | |
| | propoxylated, Ethylene oxide- | |
| | propylene oxide copolymer | |
| | mono(2-ethylhexyl) ether | |
| Tergitol L64 | EO/PO block copolymer | 9003-11-06 |
| Lutensol XL70 | Longer-chain alcohol ethoxylates | 160875-66-1 |
| Citrate Buffer | Citric acid, Sodium Citrate and | 77-92-9, |
| | Sodium Carbonate | 6132-04-3, |
| | | 497-19-8 |
| Sugafax | Sodium Decylglucosides | 740817-98-5 |
| | Hydroxypropyl Phosphate | |
| Glucopon 425N | Alkyl polyglycoside | 110615-47-9 |
| | | 68515-73-1 |
| | | 111-30-8 |
| Dyhypound M | Trade Secret | Trade Secret |
| Cola Teric CDS8 | 1-Propanaminium, 2-hydroxy-N,N- | 1612795-77-3 |
| | dimethyl-N-[3-(1- | 1310-73-2 |
| | oxooctyl)amino]propyl]3-sulfo- | |
| Urea | Carbamide | 57-13-6 |

TABLE 2
Detergent Formulations:

| | Chelator | Surfactant 1 | Surfactant 2 | Surfactant | Urea | | | Effective |
|---|---|---|---|---|---|---|---|---|
| Formula | [wt %] | [wt %] | [wt %] | 3 [wt %] | [wt %] | Buffer | Biodegradable | detergent |
| Formula #1 | Dissolvine | Ecosurf EH9 | Lutensol | Tergitol | None | Citrate | Yes | Yes |
| | GL47-S | [4%] | XL70 (2%) | L64 | | Buffer | | |
| | [3%] | | | [2%] | | pH 6-7 | | |
| Comparative | None | Propylene | Lutensol | None | None | Citrate | Yes | No |
| Formula #1 | | Glycol | XL70 | | | Buffer | | |
| | | [20%] | [4%] | | | pH 6-7 | | |
| Comparative | None | Propylene | Ecosurf SA | None | None | None | Yes | No |
| Formula #2 | | Glycol | 9 [4%] | | | | | |
| | | [20%] | | | | | | |
| Comparative | None | Propylene | Lutensol XL | Sugafax | None | None | Yes | No |
| Formula #3 | | Glycol | 70 [4%] | (4%) [4%] | | | | |
| | | [20%] | | | | | | |
| Comparative | None | Propylene | Glucopon | None | None | None | Yes | No |
| Formula #4 | | Glycol | 425N [4%] | | | | | |
| | | [20%] | | | | | | |
| Comparative | Disolvine | Dyhypound | Ecosurf EH9 | None | None | Citrate | Yes | No |
| Formula #5 | GL47S | M [4%] | [4%] | | | Buffer | | |
| | [3%] | | | | | pH 6-7 | | |
| Comparative | Disolvine | Pluronic | Ecosurf EH9 | None | None | Citrate | Yes | No |
| Formula #6 | GL47S | 10R5 | [4%] | | | Buffer | | |
| | [3%] | [4%] | | | | pH (6- | | |
| | | | | | | 7 | | |
| Comparative | Disolvine | Coteric CD | Ecosurf EH9 | None | None | Citrate | Yes | No |
| Formula #7 | GL47S | 38 [4%] | [4%] | | | Buffer | | |
| | [3%] | | | | | pH (6- | | |
| | | | | | | 7) | | |
| #8 | Disolvine | Lutensol | Ecosurf EH9 | None | None | Citrate | Yes | No |
| | GLA7S | XL70 [4%] | [4%] | | | Buffer | | |
| | [3%] | | | | | pH (6- | | |
| | | | | | | 7) | | |
| #9 | Disolvine | Dyhyphond | Ecosurf EH9 | Pluronic | None | Citrate | Yes | No |
| | GLA7S | M [4%] | [4%] | 10R5 [4%] | | Buffer | | |
| | [3%] | | | | | pH (6- | | |
| | | | | | | 7) | | |
| #10 | Disolvine | Glucopon | Ecosurf EH9 | Pluronic | None | Citrate | Yes | No |
| | GLA7S | 425N [4%] | [4%] | 10R5 [4%] | | Buffer | | |
| | [3%] | | | | | pH (6- | | |
| | | | | | | 7) | | |
| #11 | Disolvine | Lutensol | Ecosurf EH9 | Pluronic | None | Citrate | Yes | Yes |
| | GLA7S | XL70 [2%] | [4%] | 10R5 [2%] | | Buffer | | |
| | [3%] | | | | | pH (6- | | |
| | | | | | | 7) | | |
| #12 | Disolvine | Lutensol | Ecosurf EH9 | Tergitol L64 | Urea | Citrate | Yes | Yes |
| | GLA7S | XL70 [2%] | [4%] | [2%] | [10%] | Buffer | | |
| | [3%] | | | | | pH (6- | | |
| | | | | | | 7) | | |

As shown in the examples, the specific combination of chelant, surfactants, and buffer results in a detergent that is effective and biodegradable. As shown by the comparative formulas, even small substitutions in any of the chelant, surfactant, and buffer can result in a less desirable detergent.

### EXEMPLARY ASPECTS

The following exemplary aspects are provided, the numbering of which is not to be construed as designating levels of importance:

Aspect 1 provides a detergent composition comprising:
a citrate buffer;
a urea component;
a surfactant component; and
a chelator component, wherein
a pH of the detergent composition is in a range of from about 6.5 to about 9, and
at least one of the citrate buffer, surfactant component and the chelator component are biodegradable.

Aspect 2 provides the detergent composition of Aspect 1, wherein the chelator component is in a range of from about 1 wt % to about 10 wt % of the detergent composition.

Aspect 3 provides the detergent composition of any of Aspects 1 or 2, wherein the chelator component is in a range of from about 2 wt % to about 5 wt % of the detergent composition.

Aspect 4 provides the detergent composition of any of Aspects 1-3, wherein the chelator component comprises at least one chelator.

Aspect 5 provides the detergent composition of any of Aspects 1-4, wherein the chelator component comprises one chelator.

Aspect 6 provides the detergent composition of any of Aspects 1-5, wherein the chelator component comprises glutamic acid, N,N-diacetic acid tetrasodium salt.

Aspect 7 provides the detergent composition of any of Aspects 1-6, wherein the surfactant component is in a range of from about 3 wt % to about 20 wt % of the detergent composition.

Aspect 8 provides the detergent composition of any of Aspects 1-7, wherein the surfactant component is in a range of from about 4 wt % to about 12 wt % of the detergent composition.

Aspect 9 provides the detergent composition of any of Aspects 1-8, wherein the surfactant component comprises at least one surfactant.

Aspect 10 provides the detergent composition of any of Aspects 1-9, wherein the surfactant component comprises three surfactants.

Aspect 11 provides the detergent composition of Aspect 10, wherein individual surfactants of the surfactant component independently range from about 0.5 wt % to about 7 wt % of the detergent composition.

Aspect 12 provides the detergent composition of any of Aspects 10 or 11, wherein individual surfactants of the surfactant component independently range from about 1 wt % to about 6 wt % of the detergent composition.

Aspect 13 provides the detergent composition of any of Aspects 1-12, wherein the surfactant component comprises or more surfactants comprising 2-Ethyl hexanol EoPo copolymer (9 EO), Ethyl hexanol ethoxylated propoxylated, Ethylene oxide-propylene oxide copolymer mono(2-ethylhexyl) ether, EO/PO block copolymer, Longer-chain alcohol ethoxylates, or a mixture thereof.

Aspect 14 provides the detergent composition of any of Aspects 1-13, wherein the citrate buffer comprises a mixture of citric acid, sodium citrate, and sodium carbonate.

Aspect 15 provides the detergent composition of Aspect 14, wherein:
the citric acid is in a range of from about 0.03 wt % to about 0.7 wt % of the detergent composition;
the sodium citrate is in a range of from about 2 wt % to about 10 wt % of the detergent composition; and
the sodium carbonate is in a range of from about 2 wt % to about 15 wt % of the detergent composition.

Aspect 16 provides the detergent composition of any of Aspects 14 or 15, wherein:
the citric acid is in a range of from about 0.05 wt % to about 0.5 wt % of the detergent composition;
the sodium citrate is in a range of from about 5 wt % to about 8 wt % of the detergent composition; and
the sodium carbonate is in a range of from about 6 wt % to about 10 wt % of the detergent composition.

Aspect 17 provides the detergent composition of any of Aspects 1-16, wherein at least two of the citrate buffer, the surfactant component, and the chelator component are biodegradable.

Aspect 18 provides the detergent composition of any of Aspects 1-17, wherein each of the citrate buffer, the surfactant component, and the chelator component are biodegradable.

Aspect 19 provides the detergent composition of any of Aspects 1-18, wherein biodegradability is determined according to OECD Test No. 310 (2014).

Aspect 20 provides the detergent composition of any of Aspects 1-19, wherein each of the citrate buffer, the surfactant component, and the chelator component are non-toxic.

Aspect 21 provides the detergent composition of any of Aspects 1-20, wherein at least one of the citrate buffer, the surfactant component, and the chelator component are non-toxic.

Aspect 22 provides the detergent composition of any of Aspects 1-21, wherein at least two of the citrate buffer, the surfactant component, and the chelator component are non-toxic.

Aspect 23 provides the detergent composition of any of Aspects 1-22, wherein the detergent is an aqueous detergent.

Aspect 24 provides the detergent composition of any of Aspects 1-23, wherein the composition is free of an enzyme.

Aspect 25 provides the detergent composition of any of Aspects 1-24, wherein a pH of the detergent composition is in a range of from about 7 to 7.5.

Aspect 26 provides the detergent composition of any of Aspects 1-25 wherein:
the citrate buffer comprises:
   citric acid in a range of from about 0.05 wt % to about 0.5 wt % of the detergent composition;
   sodium citrate in a range of from about 5 wt % to about 8 wt % of the detergent composition; and
   sodium carbonate in a range of from about 6 wt % to about 10 wt % of the detergent composition
the surfactant component comprises
   2-Ethyl hexanol EoPo copolymer (9 EO), Ethyl hexanol ethoxylated propoxylated in a range of about 2 wt % to about 6 wt % of the detergent composition,
   Ethylene oxide-propylene oxide copolymer mono(2-ethylhexyl) ether, EO/PO block copolymer in a range of about 1 wt % to about 3 wt % of the detergent composition, and
   Longer-chain alcohol ethoxylates, or a mixture thereof in a range of about 1 wt % to about 3 wt % of the detergent composition; and
the chelator component comprises:
   glutamic acid, N,N-diacetic acid tetrasodium salt in a range of from about 2 wt % to about 5 wt % of the detergent composition.

Aspect 27 provides the detergent composition of any of Aspects 1-26, wherein the composition is a medical device detergent, a surgical instrument detergent, a hospital detergent, a laundry detergent, a dishwasher detergent, or a combination thereof.

Aspect 28 provides the detergent composition of Aspect 27, wherein the medical device is an endoscope.

Aspect 29 provides a method of using the detergent composition of any of Aspects 1-28, the method comprising applying the detergent composition to a surface.

Aspect 30 provides a method of making the detergent composition of any of Aspects 1-29, the method comprising mixing the citrate buffer, the surfactant component, and the chelator component.

What is claimed is:

1. A detergent composition comprising:
a citrate buffer;
a surfactant component;
a urea component; and
a chelator component, wherein
a pH of the detergent composition is in a range of from about 6.5 to about 9, and
at least one of the citrate buffer, surfactant component and the chelator component are biodegradable.

2. The detergent composition of claim 1, wherein the chelator component is in a range of from about 1 wt % to about 10 wt % of the detergent composition.

3. The detergent composition of claim 1, wherein the chelator component comprises at least one chelator.

4. The detergent composition of claim 1, wherein the chelator component comprises glutamic acid, N,N-diacetic acid tetrasodium salt.

5. The detergent composition of claim 1, wherein the surfactant component is in a range of from about 3 wt % to about 20 wt % of the detergent composition.

6. The detergent composition of claim 1, wherein the surfactant component comprises at least one surfactant.

7. The detergent composition of claim 1, wherein the surfactant component comprises or more surfactants comprising 2-Ethyl hexanol EoPo copolymer (9 EO), Ethyl hexanol ethoxylated propoxylated, Ethylene oxide-propylene oxide copolymer mono(2-ethylhexyl) ether, EO/PO block copolymer, Longer-chain alcohol ethoxylates, or a mixture thereof.

8. The detergent composition of claim 1, wherein the citrate buffer comprises a mixture of citric acid, sodium citrate, and sodium carbonate.

9. The detergent composition of claim 1, wherein the urea component ranges from about 5 wt % to about 20 wt % of the detergent composition.

10. The detergent composition of claim 8, wherein:
the citric acid is in a range of from about 0.03 wt % to about 0.7 wt % of the detergent composition;
the sodium citrate is in a range of from about 2 wt % to about 10 wt % of the detergent composition; and
the sodium carbonate is in a range of from about 2 wt % to about 15 wt % of the detergent composition.

11. The detergent composition of claim 10, wherein:
the citric acid is in a range of from about 0.05 wt % to about 0.5 wt % of the detergent composition;
the sodium citrate is in a range of from about 5 wt % to about 8 wt % of the detergent composition; and
the sodium carbonate is in a range of from about 6 wt % to about 10 wt % of the detergent composition.

12. The detergent composition of claim 1, wherein at least two of the citrate buffer, the surfactant component, and the chelator component are biodegradable.

13. The detergent composition of claim 1, wherein each of the citrate buffer, the surfactant component, and the chelator component are biodegradable.

14. The detergent composition of claim 1, wherein biodegradability is determined according to OECD Test No. 310 (2014).

15. The detergent composition of claim 1, wherein each of the citrate buffer, the surfactant component, and the chelator component are non-toxic.

16. The detergent composition of claim 1, wherein the detergent is an aqueous detergent.

17. The detergent composition of claim 1, wherein the composition is free of an enzyme.

18. The detergent composition of claim 1, wherein a pH of the detergent composition is in a range of from about 7 to 7.5.

19. The detergent composition of claim 1, wherein:
the citrate buffer comprises:
citric acid in a range of from about 0.05 wt % to about 0.5 wt % of the detergent composition;
sodium citrate in a range of from about 5 wt % to about 8 wt % of the detergent composition; and
sodium carbonate in a range of from about 6 wt % to about 10 wt % of the detergent composition
the surfactant component comprises
2-Ethyl hexanol EoPo copolymer (9 EO), Ethyl hexanol ethoxylated propoxylated in a range of about 2 wt % to about 6 wt % of the detergent composition,
Ethylene oxide-propylene oxide copolymer mono(2-ethylhexyl) ether, EO/PO block copolymer in a range of about 1 wt % to about 3 wt % of the detergent composition, and
Longer-chain alcohol ethoxylates, or a mixture thereof in a range of about 1 wt % to about 3 wt % of the detergent composition; and
the chelator component comprises:
glutamic acid, N,N-diacetic acid tetrasodium salt in a range of from about 2 wt % to about 5 wt % of the detergent composition.

20. The detergent composition of claim 1, wherein the composition is a medical device detergent, a surgical instrument detergent, a hospital detergent, a laundry detergent, a dishwasher detergent, or a combination thereof.
